(19) United States
(12) Patent Application Publication
(10) Pub. No.: US 2023/0394527 A1
(43) Pub. Date: Dec. 7, 2023

(54) ESTIMATING TIME FOR IMPLEMENTING CHANGES TO DISPLAY FIXTURES

(71) Applicant: Unefi Inc., Toronto (CA)

(72) Inventors: Samuel Arthur Vise, Toronto (CA); Ranko Dimic, Toronto (CA)

(21) Appl. No.: 18/029,259

(22) PCT Filed: Sep. 29, 2021
(86) PCT No.: PCT/CA2021/051363

§ 371 Date: Mar. 29, 2023

Related U.S. Application Data
(60) Provisional application No. 63/085,582, filed on Sep. 30, 2020.

(51) Int. Cl. G06Q 30/0251; G06Q 30/0241

(52) U.S. Cl. CPC G06Q 30/0257; G06Q 30/0276; G06Q 30/0268; G06Q 30/0261

(57) ABSTRACT

Systems and methods relating to estimating a time required to implement changes to a display fixture. A user enters an identification of a display fixture and a display element to be changed on the display fixture. The system retrieves change data relating to display element locations affected by the change and determines how much time, based on historical change data, the change should take.

### TECHNICAL FIELD

The present invention relates to the management of display fixtures. More specifically, the present invention relates to systems, methods, and tools relating to determining a level of effort or an amount of time necessary to implement changes to display elements in a display fixture.

### BACKGROUND

The technological and communications revolutions of the early 21st century have led to concomitant revolutions in marketing and retail management. Nowadays, marketing campaigns can be efficiently managed from a small number of locations and marketing managers can ensure uniformity of message and look when it comes to kiosks, stores, and other public facing materials. To this end, marketing planners and designers can now design and implement marketing and promotional campaigns centrally, including designing not just the kiosks used to market products but even designing the arrangement of the demonstration products on those kiosks.

The above also makes it easy for stores and other retail establishments to adjust/change the look and/or displays for marketing campaigns. The designers can now send, using detailed plans, images, and parts lists, the new marketing/promotional campaign designs to the retail establishments. The retail establishments can then simply modify/adjust their customer facing displays according to these designs.

However, one capability that current platforms do not provide is a way to determine how long it would take each retail establishment to adjust/modify their displays to accord with the new designs. Such a capability would allow these retail establishments to make staffing plans accordingly. Similarly, such a capability would allow designers to take into account, when creating/modifying the new designs, the possible labor costs for implementing the designs. As an example, a wholesale change in the look/placement multiple display fixtures in the retail establishment may require a retail establishment to shut down and retool. Because of this level of effort required, a designer may wish to, instead of a complete redesign of multiple display fixtures, implement a more gradual or phased change of these fixtures. This way, the labor costs for implementing the wholesale change would be spread out over a period of time as opposed to being a single one-time cost for the retailer. Similarly, by provided an estimated time required to modify a display fixture, retailers can properly schedule employees to efficiently implement the new designs.

There is therefore a need for innovations that allow for the estimation of time required for implementing changes to display fixtures and other public facing marketing platforms. Such methods and systems may also be applicable to fields where frequent detailed changes need to be made to physical assets and which require manpower.

### SUMMARY

The present invention provides systems and methods relating to estimating a time required to implement changes to a display fixture. A user enters an identification of a display fixture and a display element to be changed on the display fixture. The system retrieves change data relating to display element locations affected by the change and determines how much time, based on historical change data, the change should take.

In a first aspect, the present invention provides a method for determining an amount of time for implementing a proposed change in a display fixture in a retail environment, the method comprising:
a) receiving user input, said user input relating to an identification of a display fixture and at least one display element to be changed on said display fixture;
b) determining which display element locations on said display fixture are to be affected by said proposed change, said determining being based at least on said user input, said display element locations being locations on said display fixture where said at least one display element is displayed;
c) for each of said display element locations to be affected by said proposed change,
   c1) retrieving change data from a database, said change data comprising time data relating to previous changes made to a specific display element location, said specific display element location being one of said display element locations to be affected by said proposed change;
   c2) determining an average amount of time spent on executing said previous changes to said specific display element location, said average amount of time being based on said change data retrieved in step c1);
   c3) determining an estimated time to execute said proposed change to said specific display element location using said average amount of time determined in step c2);
d) aggregating estimated times to execute said proposed change to said display element locations to be affected by said proposed change to result in a total estimated time to execute said proposed change; and
e) presenting said total estimated time to a user.

In a second aspect, the present invention provides a method for tracking time spent executing changes to at least one display element in a display fixture, the method comprising:
a) receiving execution data from said user, said execution data relating to a total time spent on executing an executed change on said display fixture, said execution data comprising an identification of said at least one display element changed on said display fixture, an identification of said display fixture, and said total time spent on executing said executed change;
b) determining an average time for said executed change, said average time for said executed change being based on said total time and on a total number of display elements changed by said executed change;
c) for each display element changed by said executed change,
   c1) determining display element locations affected by changes to a specific display element by said executed change;
   c2) storing said average time in at least one storage location in said database, each of said at least one location being associated with a specific display element location affected by said changes to said specific display element by said executed change such that each storage location in said database associated with a specific display element location contains an average time for a previous executed change.

In a third aspect, the present invention provides a system for managing at least one change to at least one display element in a tangible display fixture for physical stores, the system comprising:
a database module embodied in a server, said database module managing a database containing records relating to times for implementing previous changes to display elements on said display fixture;
a processing module embodied in a server, the processing module processing an input from a user, said input detailing a specific tangible display fixture and at least one specific display element on said specific tangible display fixture, said display element being changed in said at least one change;
a planning and inventory module embodied in said server, said inventory module retrieving records from said database using said database module and enabling said user of said system to view available tangible display fixtures in a specific physical store and enabling said user to select display elements available to be changed on said available tangible display fixtures, said specific tangible display fixture being one of said available tangible display fixtures;
a presentation module embodied in said server, said presentation module enabling said user to view images of said specific display fixture, said presentation module also enabling said user to place or remove or replace images of selected display elements on an image of said specific tangible display fixture to thereby configure said tangible display fixture and to thereby virtually implement said proposed change on said specific tangible display fixture.

### BRIEF DESCRIPTION OF THE DRAWINGS

The embodiments of the present invention will now be described by reference to the following figures, in which identical reference numerals in different figures indicate identical elements and in which:

FIG. 1 is a block diagram of a system according to one aspect of the present invention;

FIG. 2 is a block diagram of a variant of the system illustrated in FIG. 1;

FIG. 3 is an example floor plan presented by the present invention to the user;

FIG. 4 is an example image of a display fixture presented to the user by the present invention with display;

FIG. 5 is a screenshot of a user interface which may be used with the present invention;

FIGS. 6A to 6C are screenshots of another user interface which may be used with the present invention.

### DETAILED DESCRIPTION

In one aspect, the present invention provides systems and methods relating to the determination of an estimated time for implementing changes to a display fixture given the display element to be changed/adjusted. The system receives a user's input that indicates a display fixture and a display element to be changed. The display element may be removed, placed, adjusted, replaced, or in any way changed from its present state. The display fixture has a number of display element locations and these display element locations are affected by the change depending on the type of the display element location and the parameters/format of the display element. As an example, a display element may be a sign promoting a sale on a specific item or service. The sign may have a number of formats or sizes and these different formats or sizes may be suited for one or more display element locations on the display fixture. As such, for a given display element, depending on the different formats in which the display element is available, different display element locations on the display fixture may be affected by the proposed change.

Once the system has received the display fixture and the display element to be changed on the display fixture, the system then determines, by accessing a suitable database, the number and type of display element locations on that specific display fixture. The system then determines, given the known formats that the display element is available in, which of these display element locations in that particular display fixture are affected by the change (i.e., which display element locations have parameters that match the available formats of the display element). For these affected display element locations, database entries of previous changes are retrieved and, for each of the affected display element locations, an average time to implement a change is calculated. The average times are then added to result in the estimated time to implement the change to the display element on the specific display fixture.

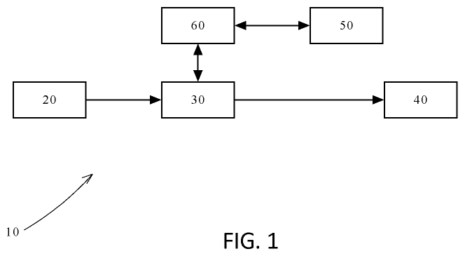

It should be clear that the system may be implemented to result in the configuration as shown in FIG. 1. The system 10 includes an input module 20, a processing module 30, and an output module 40. The processing module 30 retrieves data from a database 50 as necessary through a database module 60. It should be clear that the input module 20 may receive direct or indirect input from a user about a proposed change that affects a display fixture and a display element. Based on this input, the system passes this data to the processing module 30. The processing module then determines, based on the display fixture and on the display element, which display element locations are affected by the proposed change. It should be clear that, for the display fixture, there are only a certain number of configurations, with each configuration having specific numbers of display element locations with each having specific dimensions and parameters. For the display element, there are only a certain number of formats, each format being usable with one or more of the display element locations. The processing module 30, once it has determined the display element locations that conform to the formats for the display element, then retrieves change data for those display element locations from the database. Using the change data, an average amount of time for changing the display element in that specific display element location is then calculated. It should be clear that, for each display element location, change data is a history of changes made that involved that specific display element location and the change data includes a calculated amount of time it took to implement each change on that specific display element location.

The system retrieves change data for display element locations on a per display fixture basis. That is, change data is retrieved for each display fixture that is changed. In a preferred implementation, the calculated amount of time is updated and presented to a user, through a user interface, every time the user proposes a change (i.e., the calculated amount of time a change would require is updated in real-time or near-real-time during the planning process). However, as should be clear, in some implementations, it may be preferable to only update the calculated amount of time in response to a signal from the user (e.g., when the user activates a menu option or presses a button to calculate the time).

To illustrate the process explained above, an example is provided. In this example, a display fixture X has 10 display element locations X1-X10 and display element Y has a format that fits display element locations X3, X4, and X7, with these locations having different sizes and configurations. Display element Z has a format that fits display element locations X1, X4, X8, and X9. The database has a change history as follows for the various locations (note that the entries are time entries in minutes):

| | X1 | X2 | X3 | X4 | X5 | X6 | X7 | X8 | X9 | X10 |
|---|---|---|---|---|---|---|---|---|---|---|
| Change 1 | 10 | | 10 | | 10 | 10 | | | | |
| Change 2 | 15 | 15 | | 15 | | | 15 | 15 | | |
| Change 3 | | | 20 | | | 20 | 20 | 20 | 20 | 20 |
| Change 4 | | 30 | 30 | | 30 | 30 | | 30 | | |
| Change 5 | 17 | 17 | | 17 | | 17 | | 17 | 17 | |
| Change 6 | 10 | 10 | | 10 | | 10 | 10 | | | |
| Change 7 | | 22 | | 22 | 22 | | 22 | | | 22 |

For the proposed change to display element Y on display fixture X, the process to arrive at the estimated time would be as follows:
retrieve change data for display element locations X3, X4, and X7 as these are the locations that would be affected.
for each display element location whose change data has been retrieved, add the retrieved times. For the display element location X3, this would be 10+20+30=60. For display element location X4, this would be 15+17+10+22=64. For display element location X7, this would be 15+20+10+22=67.
for each sum, divide by the number of data points that were used to arrive at the sum to result in an average time for each display element location. For display element location X3, this would be 60/3=20. For display element location X4, this would be 64/4=16. For display element location X7, this would be 67/4=16.75
the average times for each display element location are then added together to arrive at the estimated time for the proposed change. For this example, this estimated time would be: 20+16+16.75=52.75 minutes.

For the proposed change to display element Z on display fixture X, the results of the above process are as follows:

X1−10+15+17+10=52-->52/4=13

X4−15+17+10+22=64-->64/4=16

X8−15+20+30+17=82-->82/4=20.5

X9−20+17=37-->37/4=9.25

The estimated time for a proposed change to display element Z on display fixture X would therefore be 13+16+20.5+9.25=58.75.

It should be clear that the system or the database that the system accesses to retrieve the change data has records that indicate which display fixtures have which display element locations and the parameters and requirements for each of these locations.

To enter records into the database, a user can enter the total time for a specific change to one or more display element locations on a tangible display fixture. The average time for all the affected display element locations is determined and then stored in the database associated with the specific display element location.

As an example of the above, in one example scenario, a user implemented changes to display element D on display fixture E with the display fixture E having display element locations E1-E5. The changes to display element D affected display element locations E1, E3, and E5. It took the user 10 minutes to implement the changes to display element location E1. Similarly, it took the user 15 minutes to implement the changes to display element location E3 and it took the user 13 minutes to implement the changes to display element E5. To store the data in the database, the user enters the average time for all the changes affecting the three affected locations. The total time to implement the changes is 10+15+13=38 minutes. The average time is thus 38 minutes/3 locations=12.67 minutes. This average time is then stored in the database in storage areas associated with the three locations affected by the change, i.e., E1, E3, and E5.

In another scenario, the user implements changes to display element F on the same display fixture E, but this time affecting display element locations E1, E2, E4, and E5. For these changes, it took the user 15 minutes for location E1, 17 minutes for location E2, 14 minutes for location E4, and 11 minutes for location E5. The average time for the changes is therefore (15+17+14+11)/4=57/4=14.25 minutes. This average time is then stored in the database in storage locations associated with each of the affected display element locations, i.e., E1, E2, E4, and E5.

After the above two examples, the database change data for the locations E1-E5 would thus be as follows:

| | E1 | E2 | E3 | E4 | E5 |
|---|---|---|---|---|---|
| Change 1 | 12.67 | | 12.67 | | 12.67 |
| Change 2 | 14.25 | 14.25 | | 14.25 | 14.25 |

It should be clear that the process to determine the estimated time to implement changes may be repeated for every display element to be changed for every display fixture. As well, it should be clear that the process to enter data into the database for changes may be repeated for every change for every display fixture.

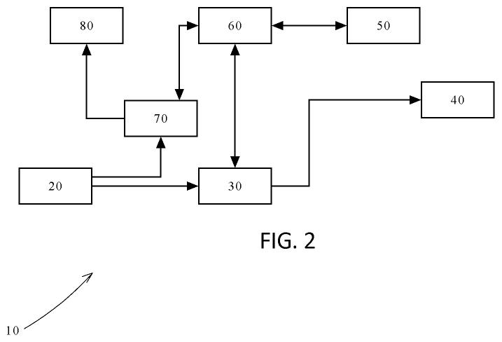

To assist the user, a planning and inventory module and a presentation module may be present in the system. Referring to FIG. 2, the system may use the planning and inventory module alongside the presentation module to provide the user with a more user-friendly experience and to provide more usability. The planning and inventory module 70 and the presentation module 80 can be used to plan changes to tangible display fixtures at specific stores or locations. The presentation module can provide the user with an overhead plan view (floor plan) of a retail location detailing location and placement of the various tangible display fixtures within the retail location. This allows the user/designer to properly plan promotional or marketing campaigns. The user/designer can then highlight which display fixture needs changes and, once highlighted, an image of that model of the display fixture (including the display elements placed on the display fixture) is presented to the user. The user can then remove/replace/adjust the various display elements on that display fixture accordingly. This allows the user to virtually design/adjust a display fixture. Once all the adjustments or changes on the display fixture have been finished, the system can then determine which display elements have been changed. With the display elements determined, the system can then estimate, for each display element affected by the changes, the time for implementing each change to a display element. The estimated time for each element (and even the total time for all the changes) can then be provided to the user and the user can use the estimated time to rethink the changes or to schedule work orders or scheduling for the changes.

It should be clear that the planning and inventory module operates with the presentation module to provide the user with images and data regarding the various display fixtures, the various display elements, and the various plans for different retail locations. These images and data are, preferably stored in a database that is accessible with and managed by the database module. Of course, this database for images and data regarding the display fixtures and display elements may be the same as or different from the database storing the change data. The presentation module and the planning and inventory modules work together to provide the system with the capability to show the user an image of each of the various models of display fixtures available in the various retail locations and allows the user to virtually place display elements on the display fixtures. The user can thus view what the final display fixture is supposed to look like after all the display elements have been placed. The ability to estimate the time to implement changes to a display fixture also provides the user with the data needed to determine how long it would take to convert one display fixture from marketing campaign configuration to another.

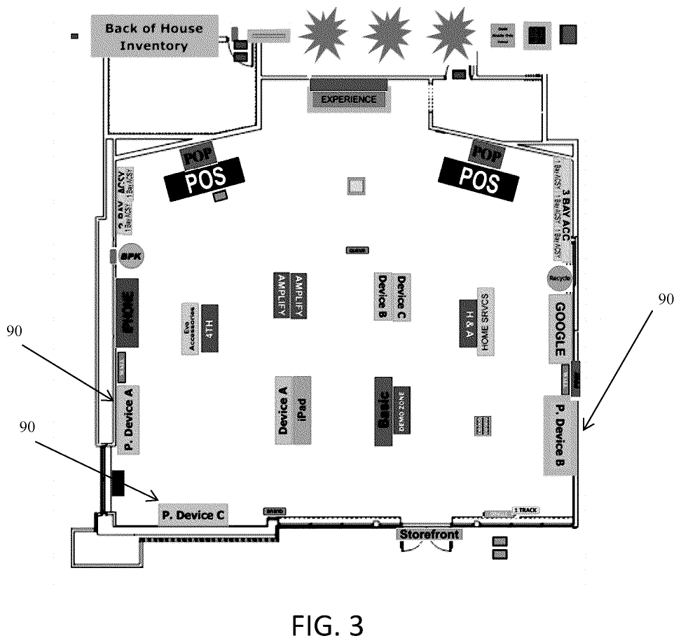

Referring to FIG. 3, illustrated is a sample floor plan of a retail location illustrating the layout and the locations of the various tangible display features 90 inside. As can be seen, the various display fixtures represented in the floor plan can be highlighted by the user and this highlighting can lead the system to present to the user an image of the display fixture. This image of the display fixture can then be amended/adjusted with images of the various display elements to arrive at the changed display fixture.

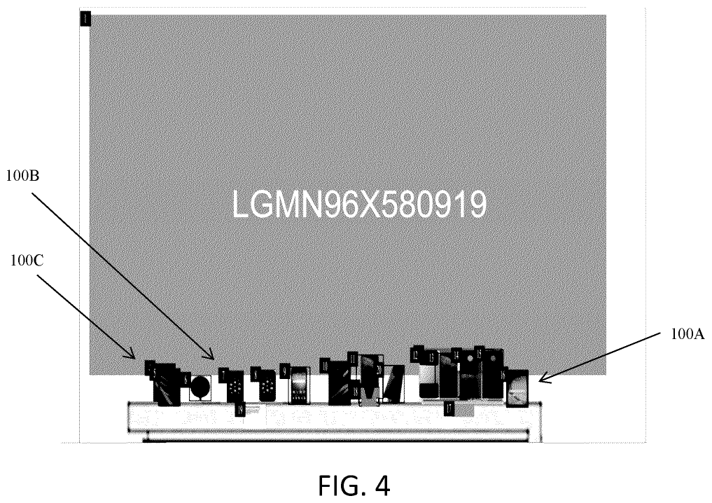

Referring to FIG. 4, illustrated is a sample display fixture with a number of display elements deployed in different display element locations. As can be seen, a number of display elements 100A, 100B, 100C are shown in the Figure. These display elements can be removed/replaced from the image of the display fixture so that the user can reconfigure the display fixture.

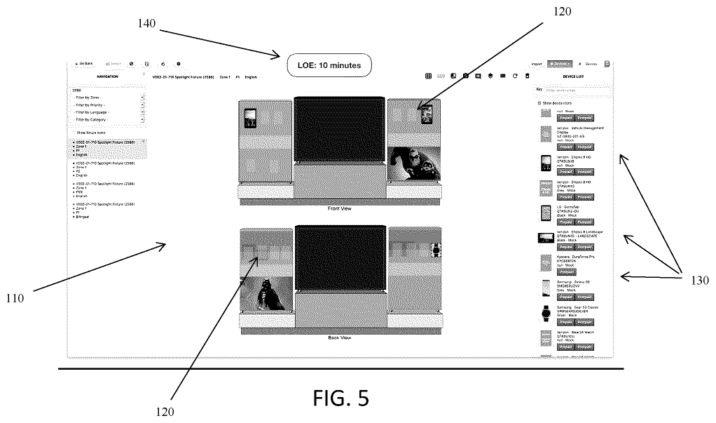

Referring to FIG. 5, another example of a user interface for provisioning a display fixture is illustrated. As can be seen, the display fixture 110 is shown with a flat screen monitor in the middle and display element locations 120 at each side of the monitor. A listing of display elements 130 available for placement on the display fixture image is provided on the right side of the user interface. In one implementation of the system, placing a display element in one of the display element locations automatically causes the system to calculate an estimate 140 of how much time is necessary to implement that placement of that display element in that display element location.

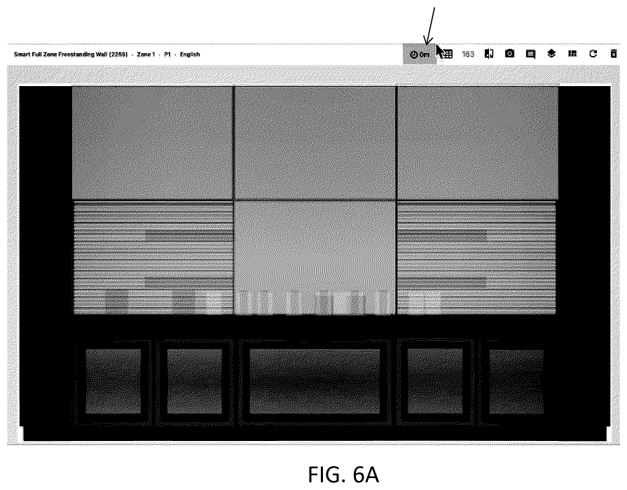

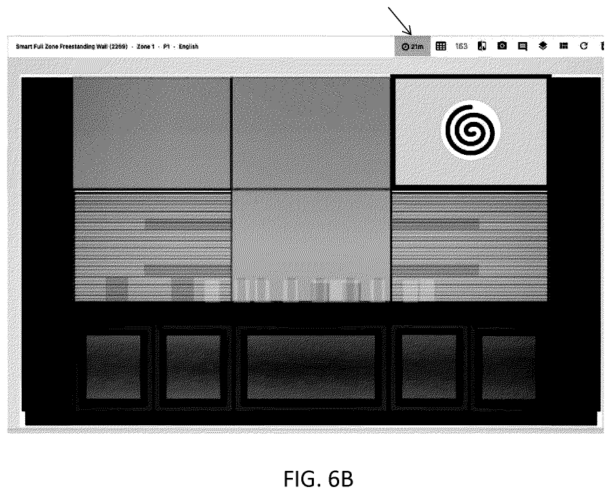

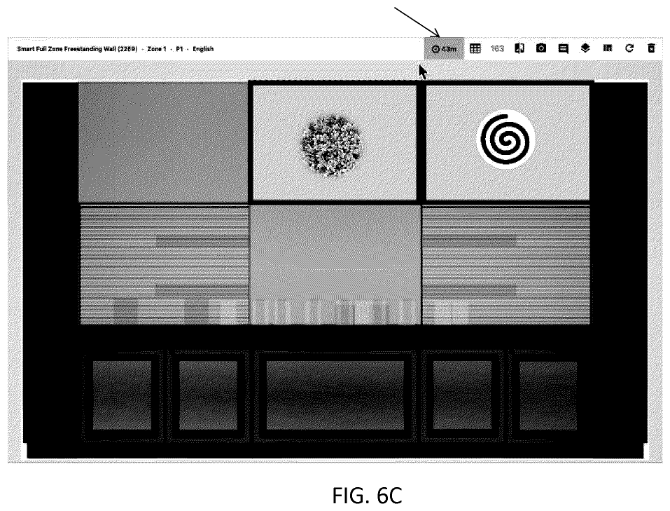

Referring to FIGS. 6A to 6C, another user interface is shown. The amount of time necessary to make proposed changes is, in this interface, highlighted in yellow at the top of the screen (pointed to by the arrow). As nothing has been changed in FIG. 6A, the calculated time is 0 minutes. As can be seen, as additional display changes are made in FIGS. 6B and 6C, the calculated time increases to reflect the additional changes.

It should be clear that the various aspects of the present invention may be implemented as software modules in an overall software system. As such, the present invention may thus take the form of computer executable instructions that, when executed, implements various software modules with predefined functions.

Additionally, it should be clear that, unless otherwise specified, any references herein to ‘image’ or to ‘images’ refer to a digital image or to digital images, comprising pixels or picture cells.

The embodiments of the invention may be executed by a computer processor or similar device programmed in the manner of method steps or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g., “C” or “Go”) or an object-oriented language (e.g., “C++”, “java”, “PHP”, “PYTHON” or “C #”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

1. A method for determining an amount of time for implementing a proposed change in a display fixture in a retail environment, the method comprising the steps of:
a) receiving user input, said user input relating to an identification of a display fixture and at least one display element to be changed on said display fixture;
b) determining which display element locations on said display fixture are to be affected by said proposed change, said determining being based at least on said user input, said display element locations being locations on said display fixture where said at least one display element is displayed;
c) for each of said display element locations to be affected by said proposed change,
c1) retrieving change data from a database, said change data comprising time data relating to previous changes made to a specific display element location, said specific display element location being one of said display element locations to be affected by said proposed change;
c2) determining an average amount of time spent on executing said previous changes to said specific display element location, said average amount of time being based on said change data retrieved in step c1);
c3) determining an estimated time to execute said proposed change to said specific display element location using said average amount of time determined in step c2);
d) aggregating estimated times to execute said proposed change to said display element locations to be affected by said proposed change to result in a total estimated time to execute said proposed change; and
e) presenting said total estimated time to a user.

2. The method according to claim 1, further comprising the steps of:
a) after executing said proposed change to result in an executed change, receiving execution data from said user, said execution data relating to a total time spent on executing said executed change on said display fixture, said execution data comprising an identification of said at least one display element changed on said display fixture, an identification of said display fixture, and said total time spent on executing said executed change;
b) determining an average time for said executed change, said average time for said executed change being based on said total time and on a total number of display elements changed by said executed change
c) for each display element changed by said executed change,
c1) determining display element locations affected by changes to a specific display element by said executed change;
c2) storing said average time in at least one storage location in said database, each of said at least one location being associated with a specific display element location affected by said changes to said specific display element by said executed change such that each storage location in said database associated with a specific display element location contains an average time for a previous executed change.

3. The method according to claim 1, further comprising the step of receiving user input to virtually change said specific display element on said tangible display fixture and presenting to said user an image of said tangible display fixture having a changed specific display element.

4. The method according to claim 1, wherein said proposed change is at least one of:
removal of said specific display element from a display element location;
replacement of said specific display element with another display element at a display element location; or
placement of said specific display element at a display element location.

5. A method for tracking time spent executing changes to at least one display element in a display fixture, the method comprising the steps of:
a) receiving execution data from said user, said execution data relating to a total time spent on executing an executed change on said display fixture, said execution data comprising an identification of said at least one display element changed on said display fixture, an identification of said display fixture, and said total time spent on executing said executed change;
b) determining an average time for said executed change, said average time for said executed change being based on said total time and on a total number of display elements changed by said executed change;
c) for each display element changed by said executed change,
c1) determining display element locations affected by changes to a specific display element by said executed change;
c2) storing said average time in at least one storage location in said database, each of said at least one location being associated with a specific display element location affected by said changes to said specific display element by said executed change such that each storage location in said database associated with a specific display element location contains an average time for a previous executed change.

6. The method according to claim 5, wherein said changes comprise at least one of:
removal of said specific display element from a display element location;
replacement of said specific display element with another display element at a display element location; or
placement of said specific display element at a display element location.

7. A system for managing at least one change to at least one display element in a tangible display fixture for physical stores, the system comprising:
a database module embodied in a server, said database module managing a database containing records relating to times for implementing previous changes to display elements on said display fixture;
a processing module embodied in a server, the processing module processing an input from a user, said input detailing a specific tangible display fixture and at least one specific display element on said specific tangible display fixture, said display element being changed in said at least one change;
a planning and inventory module embodied in said server, said inventory module retrieving records from said database using said database module and enabling said user of said system to view available tangible display fixtures in a specific physical store and enabling said user to select display elements available to be changed on said available tangible display fixtures, said specific tangible display fixture being one of said available tangible display fixtures;
a presentation module embodied in said server, said presentation module enabling said user to view images of said specific display fixture, said presentation module also enabling said user to place or remove or replace images of selected display elements on an image of said specific tangible display fixture to thereby configure said tangible display fixture and to thereby virtually implement said proposed change on said specific tangible display fixture.

8. The system according to claim 7, wherein said system is used to implement a method for determining an amount of time for implementing a proposed change in a display fixture in a retail environment, the method comprising:
a) receiving user input, said user input relating to an identification of a display fixture and at least one display element to be changed on said display fixture;
b) determining which display element locations on said display fixture are to be affected by said proposed change, said determining being based at least on said user input, said display element locations being locations on said display fixture where said at least one display element is displayed;
c) for each of said display element locations to be affected by said proposed change,
c1) retrieving change data from a database, said change data comprising time data relating to previous changes made to a specific display element location, said specific display element location being one of said display element locations to be affected by said proposed change;
c2) determining an average amount of time spent on executing said previous changes to said specific display element location, said average amount of time being based on said change data retrieved in step c1);
c3) determining an estimated time to execute said proposed change to said specific display element location using said average amount of time determined in step c2);
d) aggregating estimated times to execute said proposed change to said display element locations to be affected by said proposed change to result in a total estimated time to execute said proposed change;
e) presenting said total estimated time to a user.

9. The system according to claim 7, wherein said system is used to implement a method for tracking time spent executing changes to at least one display element in a display fixture, the method comprising:
a) receiving execution data from said user, said execution data relating to a total time spent on executing an executed change on said display fixture, said execution data comprising an identification of said at least one display element changed on said display fixture, an identification of said display fixture, and said total time spent on executing said executed change;
b) determining an average time for said executed change, said average time for said executed change being based on said total time and on a total number of display elements changed by said executed change;
c) for each display element changed by said executed change,
c1) determining display element locations affected by changes to a specific display element by said executed change;
c2) storing said average time in at least one storage location in said database, each of said at least one location being associated with a specific display element location affected by said changes to said specific display element by said executed change such that each storage location in said database associated with a specific display element location contains an average time for a previous executed change.
